(19) United States
(12) Patent Application Publication
(10) Pub. No.: US 2003/0140532 A1
(43) Pub. Date: Jul. 31, 2003

(54) Package with advertisement print and a method of producing same

(75) Inventor: Ralph Deuerling, Nuremberg (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(73) Assignee: Pizzboxx GmbH

(21) Appl. No.: 10/391,307

(22) Filed: Mar. 18, 2003

Related U.S. Application Data
(63) Continuation of application No. 09/765,139, filed on Jan. 18, 2001.

(30) Foreign Application Priority Data
Jan. 27, 2000 (DE) 200 01 348.3

(51) Int. Cl. G09F 3/00; B65D 85/00

(52) U.S. Cl. 40/312; 206/459.5

(57) ABSTRACT

A package include a container for storing a packaged product, and a cover which forms, together with the container, a cardboard box and which is integrally connected with the container along one side of the cardboard box, with the container and/or the cover being formed of a double-face corrugated cardboard and having a cardboard sheet provided on its outer surface, which forms an outer side of the cardboard box, with a advertisement print. The method of forming the package includes printing the advertisement on the cardboard sheets before they are glued to the cores formed of wavy papers.

### RELATED APPLICATIONS

This application is a continuation of application Ser. No. 09/765,139 filed Jan. 18, 2001.

### BACKGROUND OF THE INVENTION

1. Field of the Invention

The present invention relates to a package for a baked product such as, e.g., pizza, formed as a box having a container for storing the product and a cover hingedly connected with the container, with advertisements provided on the outer surface of the package. The present invention also relates to a method of producing such a package.

2. Description of the Prior Art

Such packages are generally known and can be provided with inscriptions made by the product manufacturer and containing instructions with respect to handling the stored product or describing the product. The package can also contain information about the package manufacturer or the package itself. The package can also be provided with an ornamental print which serves only for furnishing the package. Also known are packages with advertisements of third parties which differ form the package manufacturer, product manufacturer, and/or product or package supplier.

A known package with third parties advertisements is represented, e.g., by a plastic container for a product sold in a pharmacy, with the information printed thereon relating to some medicine or its manufacturer. These plastic containers are accessible only to a limited portion of the public. Also, these advertisements should relate to medicine products. Further, the print quality of the print provided on the plastic container is rather poor, and the creases of the container adversely affect the reading of the advertisement.

Accordingly, an object of the present invention is to provide a package with third parties advertisements characterized by high printing quality. Another object of the present invention is to provide a method of producing such a package.

### SUMMARY OF THE INVENTION

These and other objects of the present invention, which will become apparent hereinafter, are achieved by forming the package as a cardboard box having a container section or container and a cover section or cover, with the cover being integrally connected with the container along one side of the cardboard box, and with the container and/or the cover being formed of a double-face corrugated cardboard and having a cardboard sheet provided on its outer surface, which forms an outer side of the cardboard box, with an advertisement print.

Forming the package box of a cardboard provides for a better quality of the print. Because box planes form relatively rigid walls, the walls offer smooth surfaces for the advertisement print. As the packaged product, such as pizza, finds an extensive demand, the third parties advertisements would be accessible to a large portion of the public. Because the cardboard used is a double-face corrugated cardboard which provides more rigid surfaces for printing, the print quality is substantially improved by combining smoothness of the cardboard sheet surface with rigidity of the double-face corrugated cardboard.

The cardboard box is primarily designed for holding a pizza, which is formed as a round disc having a baked bottom with a circumferential ledge and a layer of vegetables and/or sausages placed on the baked bottom.

The advertisement print is provided on the outer surface of the cardboard box, e.g., in the bottom region of the container. However, advantageously, the advertisement print is provided on the cover as, in this case, it is particularly visible. Preferably, the print is provided on the upper surface of the cover.

The advertisement print can generally be obtained by a conventional roller printing. However, advantageously, the advertisement print is produced or formed as a four-color halftone print. The four-color halftone print, which is formed by applying primary colors in the form of halftone dots, produces a better quality print.

It is particularly preferable and advantageous when the advertisement print is formed as a reproduction of a photographic picture. The exact reproduction of a photographic picture provides for a better print quality than printing on the cardboard.

The method of producing the carbon box according to the invention includes providing a cardboard sheet of the further produced double-face corrugated cardboard with an advertisement print and gluying the cardboard sheet to the wavy paper of the core of the double-face corrugated cardboard. This permits to print the advertisement on the cardboard sheet before it is glued to the core of the double-face corrugated cardboard the container and/or the cover is (are) made of. This simplifies the manufacture of the cardboard box and permits to improve the printing process.

It is particularly preferable and advantageous when the advertisement print is obtained by the offset printing. The offset printing can be effected as a four-color halftone printing, as a roller printing, and/or as a reproduction of a photographic picture. The offset printing insures a high quality print.

It is preferable when the advertisement print occupies the entire outer surface of the container and the cover. Providing the advertisement over the entire outer surface of the box improves its appearance and increase the effect of the advertisement.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a plan view of a package with an advertisement print according to the present invention with a cut-out; and

FIG. 2 a cross-sectional view of a portion of the package shown in FIG. 1 at an increased scale.

### DETAILED DESCRIPTION OF THE PREFERRED EMBODIMENT

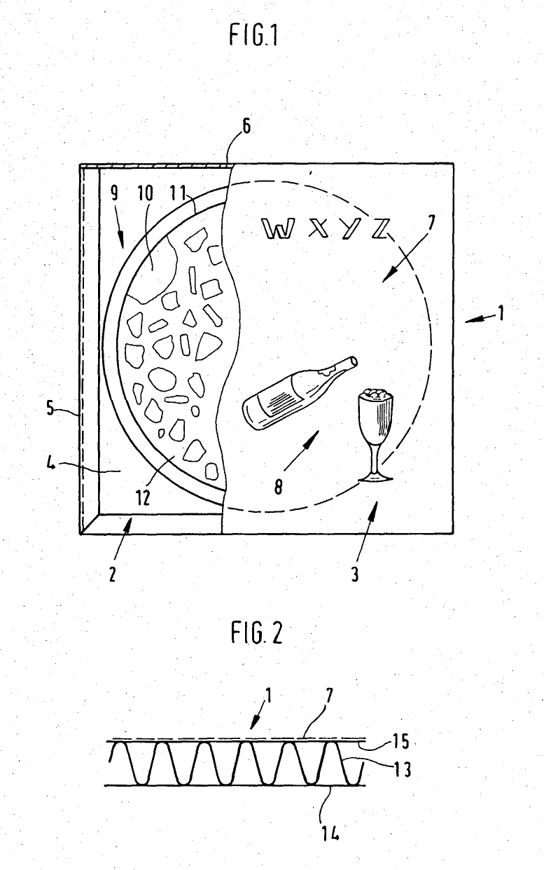

The package according to the present invention, which is shown in FIG. 1, represents a flat cardboard box 1 having a rectangular shape and essentially consisting of a container 2 and a cover 3. The container 2 has a bottom 4 and a lower wall 5 having a side 6 carrying the cover 3 hingedly connectable with the side 6. On the outer side of the cover 3, there is provided an advertisement print 7 including a picture 8 formed as photo-reproduced picture. In the cardboard box 1, there is located a pizza 9 which represents a packed product. The pizza 9 is a round disc. The pizza 9 includes a baked bottom 10 with a circumferential ledge 11, and a layer 12 provided on the bottom 10 and consisting of, e.g., vegetable and sausages.

The cardboard box 1 is formed of a corrugated cardboard, as shown in FIG. 2. The cardboard is a double-face corrugated cardboard having a core 13 formed of a wavy paper. On opposite sides of the core 13, there are provided paper sheets 14 and 15 of which the sheet 15 is provided with an advertisement print 7 which is printed on the sheet 15 before it is glued to the core 13. The paper sheet 15 with the advertisement print 7 is then glued to the wavy paper forming the core 13.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A package, comprising a container for storing a packaged product; and a cover which forms, together with the container, a cardboard box and which is integrally connected with the container along one side of the cardboard box,
wherein at least one of the container and the cover is formed of a double-face corrugated cardboard and has a cardboard sheet provided on an outer surface thereof, which forms an outer side of the cardboard box, with a advertisement print.

2. A package as set forth in claim 1, wherein the at least one of the container and the cover is the cover.

3. A package as set forth in claim 1, wherein the advertisement print is formed as a four-color halftone print

4. A package as set forth in claim 1, wherein the advertisement print is formed as a reproduction of a photographic picture.

5. A package as set forth in claim 1, wherein the advertisement print is formed by roller printing.

6. A package as set forth in claim 1, wherein the double-face corrugated cardboard has a core formed of a wavy paper, and the cardboard sheet is glued to the core.

7. A package as set forth in claim 1, wherein the advertisement print is formed by offset printing.

8. A package as set forth in claim 1, wherein both the container and the cover have an advertisement print on outer sides thereof and covering the entire outer sides of both the container and the cover.

9. Method of producing a package including a container for storing a package product and a cover which forms, together with the container, a cardboard box, the method of comprising the steps of: printing an advertisement on a cardboard sheet; thereafter, gluing the cardboard sheet with an advertisement print to a core of a wavy paper of a double-face corrugated cardboard; and forming at least one of the container and the cover of the double-face corrugated cardboard, with the cardboard sheet with the advertisement print being provided on an outer surface of the at least one of the container and the cover and which forms an outer side of the cardboard box.

10. Method as set forth in claim 9, wherein the printing step includes printing the advertisement on the cardboard sheet by offset printing.

11. Method according to claim 9, wherein the printing step includes printing the advertisement on the cardboard sheet by four-color half tone print.

12. Method as set forth in claim 9, wherein the printing step includes forming the advertisement print as a reproduction of a photographic picture.

13. Method as set forth in claim 8, wherein the printing step includes forming the advertisement print by roller printing.

14. Method as set forth in claim 9, wherein the printing step includes printing the advertisement on another cardboard sheet, and wherein the forming step includes forming another of the container and the cover of the double-face corrugated cardboard.
